(19) United States
(12) Patent Application Publication
(10) Pub. No.: US 2002/0063168 A1
(43) Pub. Date: May 30, 2002

(54) Washer jet

(75) Inventor: Helmut Pfalzgraf, Steinbach (DE)

Correspondence Address: Martin A. Farber, Suite 473, 866 United Nations Plaza, New York, NY, 10017, US

(73) Assignee: Mannesmann VDO AG

(21) Appl. No.: 10/052,105

(22) Filed: Apr. 20, 2001

Related U.S. Application Data
(63) Continuation of application No. 09/389,848, filed on Sep. 2, 1999.

(30) Foreign Application Priority Data
Sep. 15, 1998 (DE) 198 42 242.3

(51) Int. Cl. B05B 1/10

(52) U.S. Cl. 239/284.2; 239/284.1

(57) ABSTRACT

In the case of a washer jet (15) with a supporting arm (16) which can be moved in a guide (20), an operating position of the washer jet (15) which is advantageous for cleaning a headlight (2) is achieved by means of a defined pivoting movement. For this purpose, the supporting arm (16) has two movably connected segments (18, 19) which are pivoted automatically into the operating position shown by means of a spring element (22) after being extended from the guide (20). The spray angle thereby achieved, which is advantageous for cleaning the headlight (2), allows a significant improved in cleaning performance. At the same time, the washer jet (15) can also be used in the case of restricted space conditions are requires only one drive.

The invention relates to a washer jet for a vehicle, which is arranged on a supporting arm, the supporting arm being arranged in a guide in such a way that it can be moved by means of a drive from a rest position into an operating position.

Washer jets of the type stated are used in today's motor vehicles in order to spray a jet of washing liquid in a targeted manner against a desired surface to be cleaned. Apart from the windscreen, this applies, in particular, to the lens of a headlight, which often does not have a wiper. Here, the washer jet must first of all be moved into a position advantageous for the washing operation to ensure that the jet of washing liquid achieves an adequate cleaning effect. For reasons of appearance and also due to higher requirements as regards a design of the body which is favorable in terms of flow, a largely set-back arrangement of the washer jet in the rest position is desired here. The mobility of the washer jet required for this purpose is achieved by means of the supporting arm, which moves the washer jet out of a recess in a front body element, the said recess being closed, for example, by means of a cover, into the optimum operating position. In the rest position, the washer jet is therefore arranged largely protected from environmental influences in the interior of the body.

In the case of vehicles with headlights that are aligned largely vertically with a bumper arranged in front of them, washer jets of the type described can be arranged without difficulty, but modern body shapes with sharply raked headlights are increasingly making for difficulties. For this purpose, the washer jet must be moved horizontally forwards a long way on a relatively long supporting arm and the jet of washing fluid strikes the headlight at a shallow angle. The fact that the cleaning effect is impaired by the shallow angle has a disadvantageous effect.

Consideration has already been given to moving the supporting arm essentially vertically out of a body area in front of the headlights in order in this way to permit a more favorable spray angle. The disadvantage here is that the bumper is now embodied as an integral part of the body structure and offers hardly sufficient installation space for movable washer jets. In addition, this area is designed as a deformation zone and is therefore not very suitable for the installation of the supporting arm.

The problem on which the invention is based is to design a washer jet of the type stated in such a way that cleaning performance is significantly improved and operating reliability is simultaneously increased.

According to the invention, this problem is solved by virtue of the fact that the supporting arm is embodied so as to be elastically deformable and pivotable from a rest position into an operating position by means of the guide. As a result, the washer jet can be pivoted into an optimum operating position in front of the object to be cleaned, in particular the lens, in a manner largely independent of the installation position. The cleaning performance of the washer jet positioned in this way can thereby be increased considerably. By virtue of the elastic deformation, there is no need for an additional drive to be provided.

A particularly advantageous development of the invention is obtained if the supporting arm is preloaded in its rest position by means of the guide. As a result, the supporting arm returns automatically into its largely relaxed shape when it is moved out of the rest position into the operating position. Only a small installation space is required here and even complex shapes can be achieved, in particular by the elimination of a joint.

It is particularly advantageous here if the supporting arm is curved and can be moved by means of the guide out of a stretched rest position into an essentially stress-free operating position. This embodiment, which is at the same time economical to produce, is associated with only a low outlay on assembly.

The supporting arm could be composed of an elastic material, for example a conduit element, preshaped in accordance with the desired operating position. A particularly advantageous development of the invention is obtained, on the other hand, if the supporting arm is preloaded by means of a spring element. A spring element of this kind can be integrated into supporting-arm constructions known per se in a simple manner and thereby allows versatile use. At the same time, comparatively large preloading forces can be achieved, allowing reliable and fault-free positioning in the operating position, particularly at high vehicle speeds.

For this purpose, the supporting arm could, for example, comprise a hose which accommodates an appropriate spring element in its interior. Another, particularly advantageous embodiment of the invention is obtained, on the other hand, if the supporting arm has a plurality of segments which are connected movably to one another. The individual segments have a comparatively high dimensional stability, allowing them to transmit even axial forces without problems and thus allowing the advance to be initiated from the rear. Another conceivable means of achieving this is to use a piston that can be displaced in a tubular guide by means of the pressure of the washing liquid.

Another particularly advantageous embodiment of the invention is obtained if the supporting arm can be moved by means of the guide from a largely relaxed rest position into an elastically deformed operating position. In this arrangement, the supporting arm is deformed against its restoring force as it is moved from the rest position into the operating position. For example, the guide can be embodied as a curved surface against which the supporting arm is displaced. This allows a universally applicable embodiment to be achieved, one which can, in particular, be easily adjusted or adapted to various applications.

A particularly effective means for this purpose is a development of the invention in which the guide is embodied to allow relative translatory movement of mutually opposite sections of the supporting arm. Here, the elastically deformable supporting arm is moved at different rates of advance, thereby leading to a bending stress. The progressive bending is determined by the differences in the rates of advance. The supporting arm thus moves on an exactly predeterminable path, allowing the cleaning effect to be further enhanced.

A development of the invention is particularly suitable for this purpose if the supporting arm has mutually opposite rows of teeth into which respective gear wheels of differing pitch engage. This allows a deformation in a plane transverse to the direction of advance to be achieved, the curvature of the supporting arm depending on the difference in the rate of advance. In this arrangement, both the gear wheels and the rows of teeth can be of different designs. It is also possible for a common drive to be provided for both gearwheels, for example. Embodiments in which the gearwheels bring about only a difference in the rate of advance, independently of the drive, or which have a row of teeth only on one side are also conceivable.

A particularly advantageous development of the invention is obtained if the guide has a pin wheel and the supporting arm has two parallel rows of mutually spaced bars in which the pin wheel engages. It is thereby possible to simultaneously achieve the forward drive and the elastic deformation with just one pin wheel. This allows the drive to be of space-saving and economical construction.

Another advantageous embodiment of the invention is obtained if the washer jet is arranged in such a way as to be pivotable relative to the supporting arm. This makes it possible to achieve a pivoting movement of the washer jet in addition to the translatory movement of the supporting arm, allowing the washing liquid to be distributed in an optimum manner on the surface to be cleaned. The washer jet can, for example, be pivotable in a plane transverse to the direction of translation of the supporting arm.

It is also advantageous if the supporting arm can be moved by electric motor. This allows the speed of movement to be matched in an optimum manner to the spraying process and thus allows the cleaning effect to be further enhanced.

The invention allows various embodiments. Three of these are shown in the drawing and described in the following text to further clarify their basic principle. The drawing is a lateral, partially sectioned basic representation in which

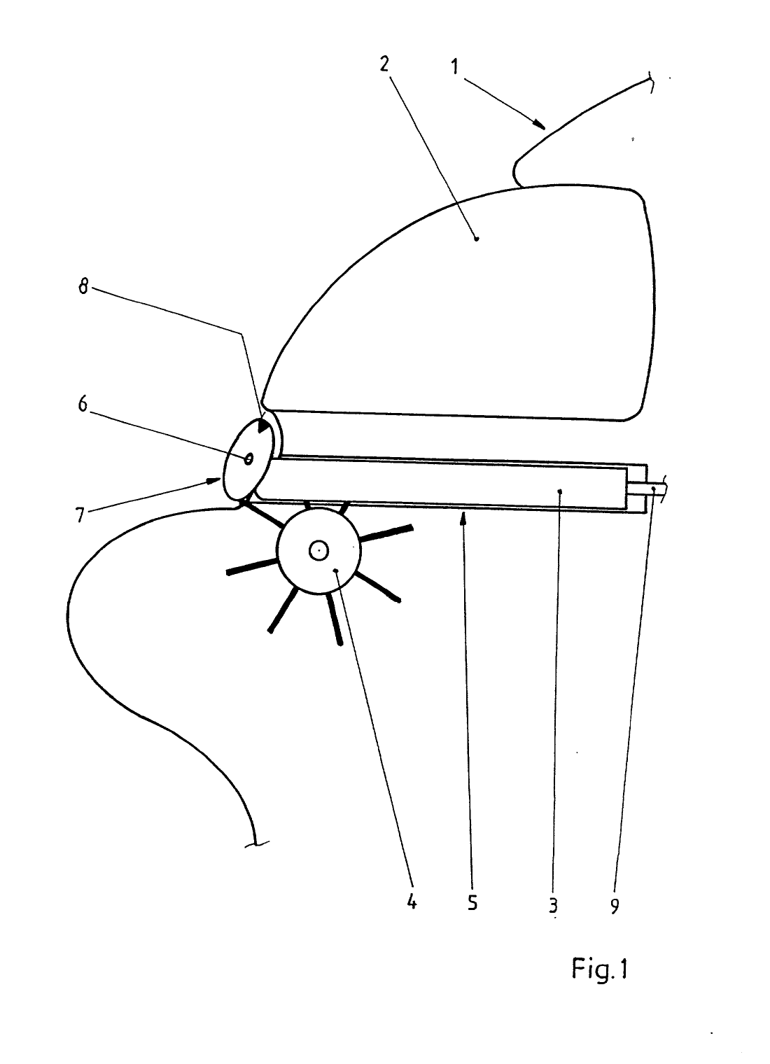

FIG. 1 shows a washer jet which can be moved by means of a pin wheel, in a rest position,

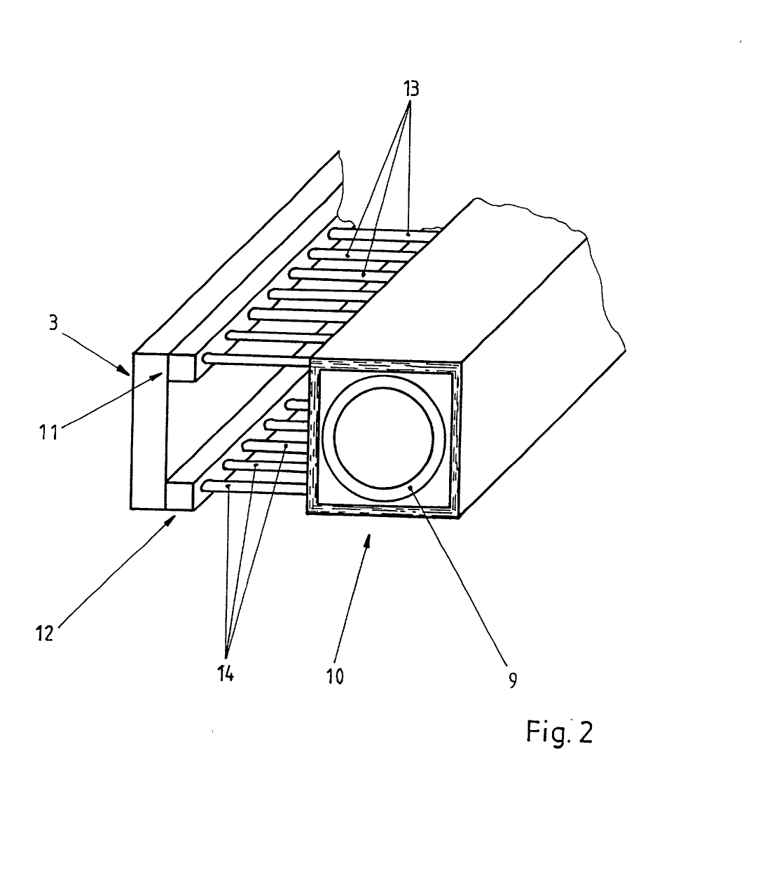

FIG. 2 shows part of the supporting arm shown in FIG. 1, in perspective view,

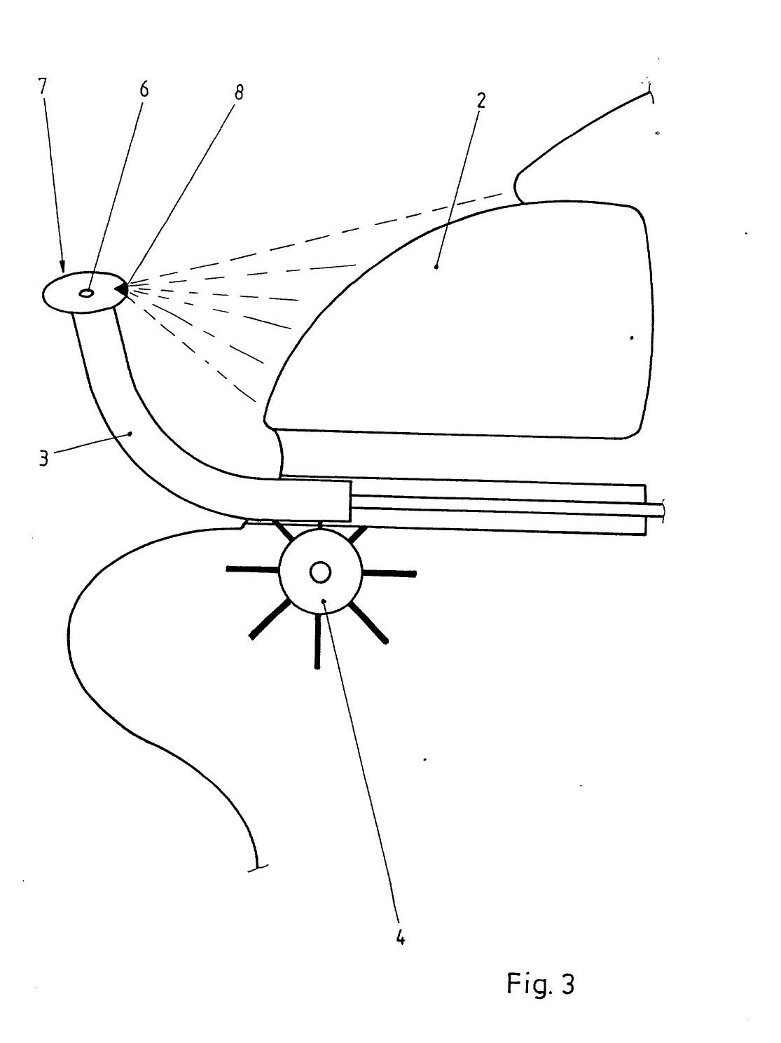

FIG. 3 shows the washer jet illustrated in FIG. 1, in an operating position,

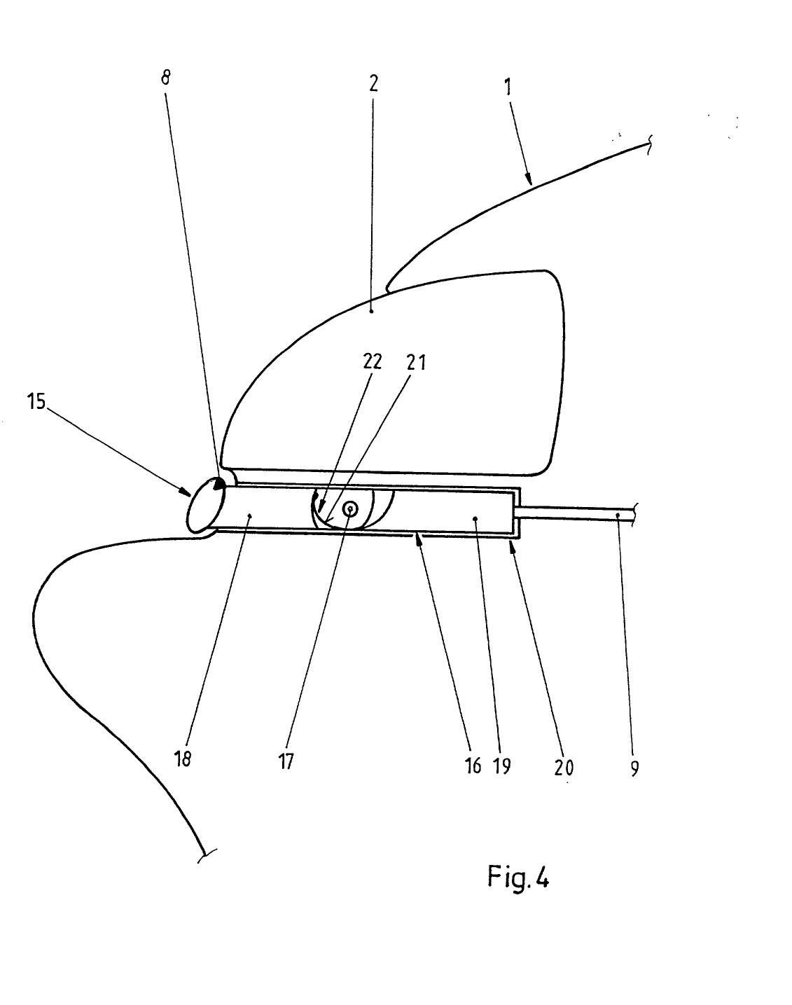

FIG. 4 shows another washer jet, which is preloaded in its rest position,

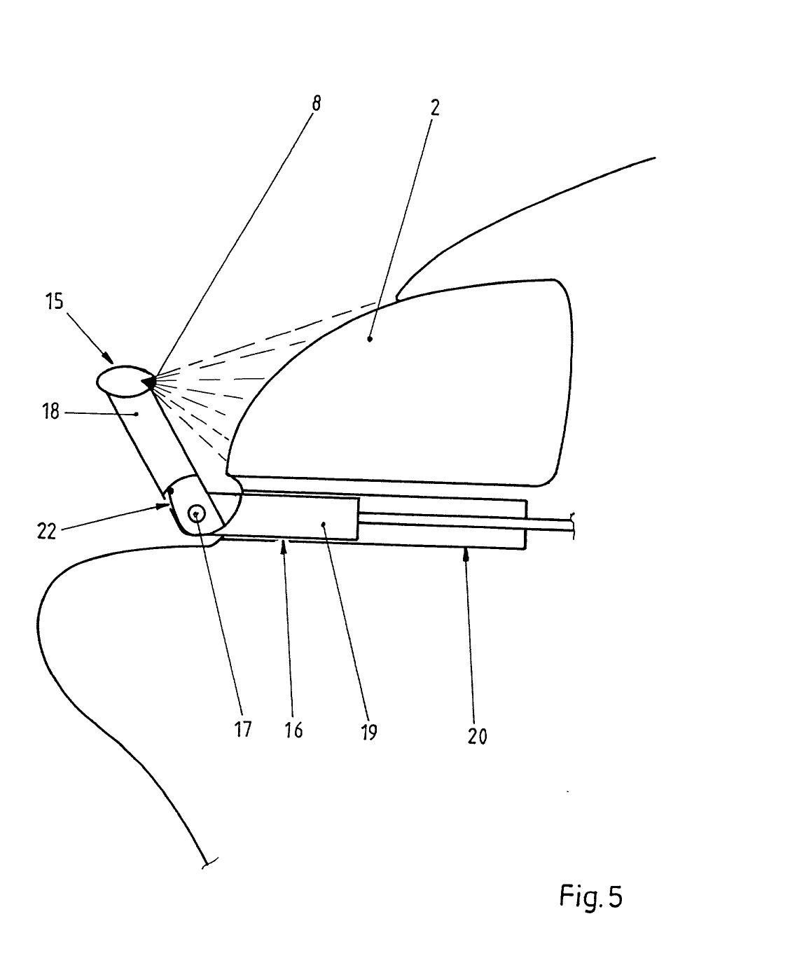

FIG. 5 shows the washer jet illustrated in FIG. 4, in an operating position,

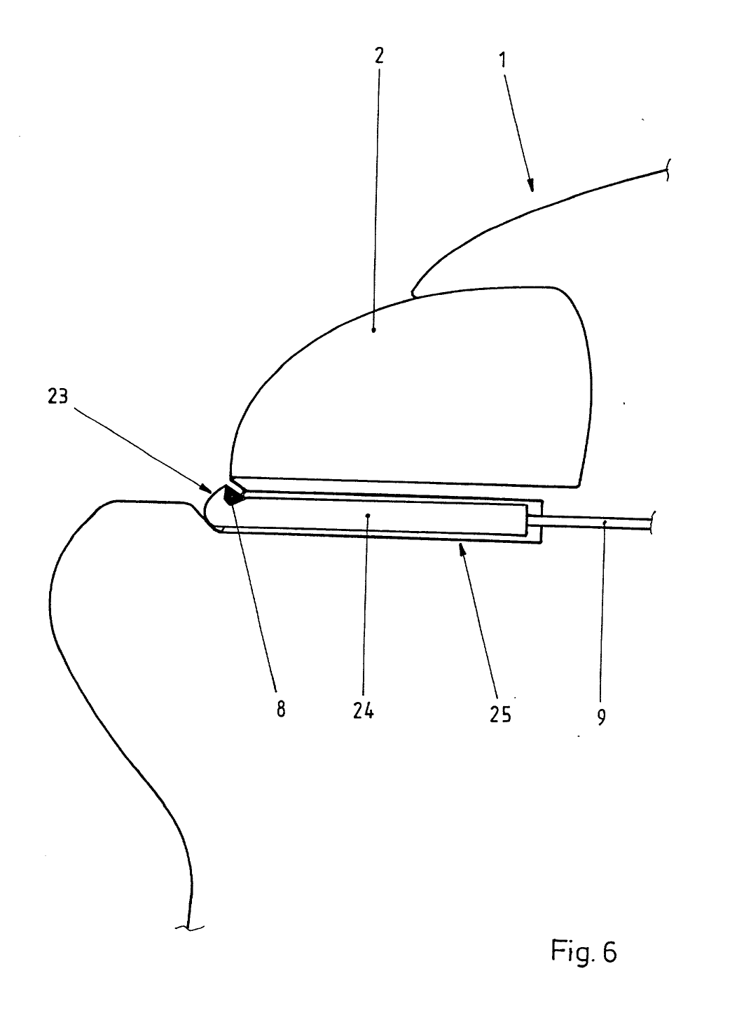

FIG. 6 shows another washer jet in a rest position,

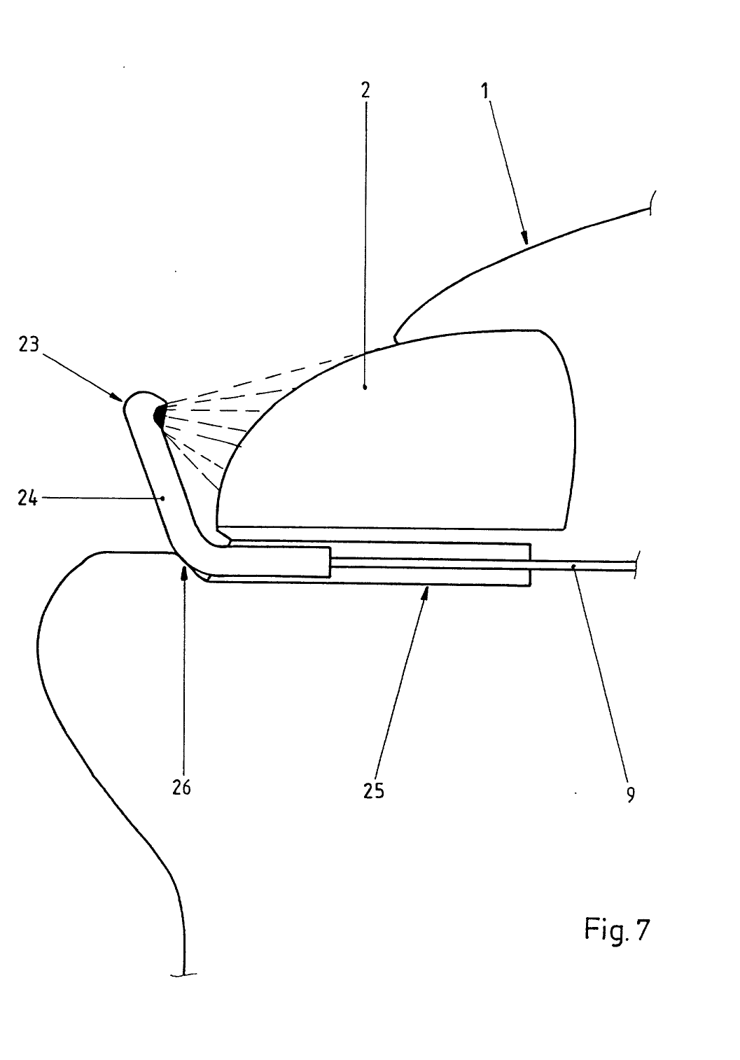

FIG. 7 shows the washer jet illustrated in FIG. 6, in an elastically deformed operating position.

FIG. 1 is a side view of a front part of a body 1 with a headlight 2. A supporting arm 3 is arranged under the headlight 2 in such a way that it can be moved by means of a guide 5 having a pin wheel 4. At its front end, the supporting arm 3 carries a washer jet 7 which can be moved about an axis 6 and has a nozzle opening 8. In the rest position illustrated, the washer jet 7 does not project relative to the outline of the body 1. At the rear, the supporting arm 3 is connected to a conduit element 9 for a washing liquid.

FIG. 2 shows, in a perspective view, part of the supporting arm 3 shown in FIG. 1. It shows a holder 10 for the conduit element 9 and two parallel rows 11, 12 of individual bars 13, 14. The bars 13 of the upper row 11 are further apart than the bars 14 of the lower row 12. In operation, the pin wheel 4 shown in FIG. 1 engages in both rows 11 and 12 simultaneously, the pitch of the lower row 12 being greater due to the smaller distance between the bars 14. This causes the supporting arm 3 to curve upwards, as illustrated in FIG. 3.

FIG. 3 shows the operating position of the washer jet 7. Here, the supporting arm 3 has been moved to such an extent by means of the pin wheel 4 that the jet of washing liquid emerging from the nozzle opening 8 strikes the headlight 2 at an advantageous angle. Here, the washer jet 7 is tilted about the axis 6 relative to the supporting arm 3, allowing the cleaning effect to be further improved. Apart from permitting exact positioning of the washer jet 7 in front of the headlight 2, the elastic deformation of the supporting arm 3 that can be achieved by means of the pin wheel 4 also simultaneously permits stiffening in the operating state by virtue of the internal stressing of the supporting arm 3, with the result that, in particular, the airflow striking the supporting arm 3 does not cause any unwanted deflection or vibration of the supporting arm 3.

FIG. 4 shows another embodiment of a washer jet 15 with a supporting arm 16 preloaded in the rest position illustrated. For this purpose, the supporting arm 16 has two segments 18, 19 which are connected to one another movably by means of a joint 17 and are stretched in the interior of a tubular guide 20 against the force of a spring element 22 embodied as a leaf spring 21. The washer jet 15, which is connected to the front segment 18, does not project relative to the outline of the body 1, and the nozzle opening 8 of the washer jet 15 is thus arranged protected from environmental influences underneath the headlight 2. The conduit element 9 is passed through the interior of the essentially hollow supporting arm 16 to supply the washer jet 15 with washing liquid.

The operating position of the washer jet 15 illustrated in FIG. 4 is shown in FIG. 5. In this position, the rear segment 19 of the supporting arm 16 is still largely held in the guide 20, while the front segment 18 has been pivoted upwards about the joint 17 by means of the spring force of the spring element 22. As a result, the nozzle opening 8 of the washer jet 15 is in an optimum position for cleaning the headlight 2.

FIG. 6 shows a simplified embodiment of a washer jet 23 according to the invention, in a rest position. Here, the washer jet 23 is connected in one piece to an elastic supporting arm 24, which is arranged displaceably in an essentially tubular guide 25. The washer jet 23 together with the nozzle opening 8 is set back below the headlight 2 relative to the outline of the body 1 and is connected to the conduit element 9 for the purpose of supplying washing liquid.

In the operating position, shown in FIG. 7, of the washer jet 23, the supporting arm 24 has been extended to a large extent out of the guide 25, and it rests against a front portion 26 of the guide 25 and is thereby deformed elastically. As a result, the washer jet 23 has been pivoted into an operating position which is advantageous for cleaning the headlight 2. Other embodiments in which the front section 26 can be matched individually and hence to a desired operating position of the washer jet 23 relative to the outline of the body 1 can also be implemented. The conduit element 9 can furthermore be connected in one piece to the supporting arm 24 and, for example, be embodied as a hose conduit. The supporting arm 24 could furthermore also be shaped in a manner approximating to the operating position and be held in an elastically deformed, in particular stretched rest position, against its restoring force by means of the guide 25.

1. A washer jet for a vehicle, which is arranged on a supporting arm, the supporting arm being arranged in a guide in such a way that it can be moved by means of a drive from a rest position into an operating position, wherein the supporting arm (3, 16, 24) is embodied so as to be elastically deformable and pivotable from a rest position into an operating position by means of the guide (5, 20, 25).

2. The washer jet as claimed in claim 1, wherein the supporting arm (16, 24) is preloaded in its rest position by means of the guide (20, 25).

3. The washer jet as claimed in claim 1 or 2, wherein the supporting arm (24) is curved and can be moved by means of the guide (25) out of a stretched rest position into an essentially stress-free operating position.

4. The washer jet as claimed in at least one of the preceding claims, wherein the supporting arm (16) is preloaded by means of a spring element (22).

5. The washer jet as claimed in at least one of the preceding claims, wherein the supporting arm (16) has a plurality of segments (18, 19) which are connected movably to one another.

6. The washer jet as claimed in at least one of the preceding claims, wherein the supporting arm (3) can be moved by means of the guide (5) from a largely relaxed rest position into an elastically deformed operating position.

7. The washer jet as claimed in at least one of the preceding claims, wherein the guide (5) is embodied to allow relative translatory movement of mutually opposite sections of the supporting arm (3).

8. The washer jet as claimed in claim 7, wherein the supporting arm (3) has mutually opposite rows of teeth into which respective gear wheels of differing pitch engage.

9. The washer jet as claimed in claim 7 or 8, wherein the guide (5) has a pin wheel (4) and the supporting arm (3) has two parallel rows (11, 12) of mutually spaced bars (13, 14) in which the pin wheel (4) engages.

10. The washer jet as claimed in at least one of the preceding claims, wherein the washer jet (7) is arranged in such a way as to be pivotable relative to the supporting arm (3).

11. The washer jet as claimed in at least one of the preceding claims, wherein the supporting arm (3, 16, 24) can be moved by electric motor.
